(19) United States
(12) Patent Application Publication
(10) Pub. No.: US 2023/0328494 A1
(43) Pub. Date: Oct. 12, 2023

(54) DISTRIBUTED BODY AREA NETWORK COMPUTING SYSTEM, METHOD AND COMPUTER PROGRAM PRODUCTS

(71) Applicants: Shreyas Sen, West Lafayette, IN (US); Angik Sarkar, West Lafayette, IN (US)

(72) Inventors: Shreyas Sen, West Lafayette, IN (US); Angik Sarkar, West Lafayette, IN (US)

(21) Appl. No.: 17/658,622

(22) Filed: Apr. 8, 2022

(51) Int. Cl. H04W 4/80

(52) U.S. Cl. CPC H04W 4/80; H04W 84/18

(57) ABSTRACT

The present invention relates to system, method and computer program products for a distributed body area network (BAN) computing system equipped with powerful distributed computing and plurality of sensors including but not limited to: one or more cameras capturing the view, depth camera, neuromorphic event-driven camera, LiDAR, microphone, speaker, biopotential sensors like electrocardiogram (ECG), electromyography (EMG) sensor, and battery. At least one of the devices in the distributed BAN computing system may be a lightweight head-mounted device communicating with a “computing hub”, present elsewhere in the BAN, via wired mode or wireless personal area network or body area network communication protocols including but not limited to Bluetooth, near field communication, Wi-Fi, human body communication.

### FIELD OF INVENTION

The present invention relates to system, method and computer program product for facilitating distributed computing for body area network devices such as a lightweight “head mountable” devices and a plurality of sensors configured to collect data and send data stream to one or more computing units for further processing.

### BACKGROUND OF THE INVENTION

There are numerous wireless devices people are putting in or on their bodies. The list includes wireless earbuds, smartwatches, smartphones and virtual-reality headsets. Technologies still in development, such as smart contact lenses that display information and digital pills that transmit sensor data after being swallowed. All of these devices need to transmit data securely at low power and over a short range. That's why researchers have started to think about them as individual components of a single human-size wireless network, referred to as a body-area network. The term “Internet of Bodies” (IoB) is also coming into use, taking a cue from the Internet of Things.

At the moment, IoB devices use established wireless technologies, mainly Bluetooth, to communicate. While these technologies are low power, well understood, and easy to implement, they were never designed for IoB networks. One of Bluetooth's defining features is the ability for two devices to easily find and connect to one another from meters away. That feature is precisely what allows a hypothetical attacker to snoop on or attack the devices on someone's body. Wireless technologies have also been designed to travel through air or vacuum, not through the medium of the human body, and therefore they are less efficient than a method of communicating designed to do so from scratch.

As such, there is need to improve the overall function of head-mounted devices including the transmission of data securely for rendering by said headsets

Several prior attempts to deal with some of the problems described have been utilized as set forth below:

According to an article in the IEEE, Purdue University researchers have developed a new method of communication that will keep medical devices, wearables, and any other devices on or near the body more secure than they are using low-power wireless signals to communicate with one another. The system capitalizes on the human body's innate ability to conduct tiny, harmless electrical signals to turn the entire body into a wired communication channel. By turning the body into the network, we will make IoB devices more secure.

United States Patent Publication No. US10078917B1 relates to a method that includes 10 rendering a first view of a three-dimensional virtual scene comprising a view of first content being displayed on a virtual display device form a location in the three-dimensional virtual scene. The method may also include rendering a second view comprising one or more content objects.

Taiwanese Patent Publication No. TW201937238A relates to a virtual or augmented reality head that includes two lens groups for two side by side displays on the display displayed within the headset. The two-dimensional image is imaged to forma virtual stereoscopic three-dimensional image; each lens group includes a main lens, a first tunable lens for correcting spherical refractive error in the user's far vision, and a second tunable lens for correcting astigmatism.

United States Patent Publication No. US10816807B2 relates to a virtual or augmented reality device is provided. The virtual or augmented reality device may include at least one visualization device and at least one computer that may be communicatively linked.

Japanese Patent Publication No. JP6510606B2 relates to a virtual or head-mounted device comprising a frame including opposing arm members and a bridge portion positioned 5 intermediate the opposing arm members; and a pair of virtual or augmented reality eyepieces, each having an optical center, the pair of virtual or augmented reality eyepieces movable to the frame to allow adjustment of the interpupillary distance between the optical centers.

However, all wearable devices, as in the examples mentioned above are bulky since computing unit, sensors and powerful battery all present inside within the device. Also, powerful computing units demands powerful and heavier battery resulting in a bulky wearable computing device for user. There is accordingly a need for solution that shift computing load from a wearable device to the device to which the wearable device, such as a headset is electronically coupled.

### REFERENCES

1. Sen, S., Maity, S., & Das, D. (2020). Turning the Body Into a Wire. Retrieved 8 Feb. 2022, from https://spectrum.ieee.org/turning-the-body-into-a-wire
2. https://patents.google.com/patent/US20120092155
3. https://spectrum.ieee.org/turning-the-body-into-a-wire
4. https://standards.ieee.org/standard/802_15_6-2012. html
5. https://standards.ieee.org/standard/802_15_4-2020. html
6. https://standards.ieee.org/standard/802_15_3-2016. html

### SUMMARY OF THE INVENTION

The following summary is an explanation of some of the general inventive steps for the system, method, architecture and tools in the description. This summary is not an extensive overview of the invention and does not intend to limit the scope beyond what is described and claimed as a summary.

In summary, the present invention in some embodiments thereof relates to system, method and computer program products for a distributed body area network (BAN) computing system equipped with powerful distributed computing and plurality of sensors which may include but are not limited to: one or more cameras capturing the view, depth camera, neuromorphic event-driven camera, LiDAR, microphone, speaker, biopotential sensors like electrocardiogram (ECG), electromyography (EMG) sensor, and battery (or power source).

Preferably, at least one of the devices in the distributed BAN computing system may be a lightweight head-mounted device communicating with a “computing hub” comprising an electronic computing device, present elsewhere in the BAN, via wired mode or wireless personal area network or body area network communication protocols including but not limited to Bluetooth, near field communication, Wi-Fi, human body communication.

In an embodiment of the present invention, the head-mounted device is equipped with plurality of sensors including but not limited to: front camera, side camera, microphone, speaker, and battery.

In an embodiment of the present invention, the head-mounted device is designed to be worn as an over the ear headset.

In an embodiment of the present invention, the head-mounted device is communicably coupled to user's computing device that may include but not limited to: phone, phablet, tablet, laptop, computer, etc. to send streams of data collected from various sensors in the head-mounted device to the wired or wirelessly coupled electronic computing device.

In an embodiment of the present invention, a computer program application may be provided along with head-mounted device providing user full control over the head-mounted device. In yet another embodiment of the present invention, the provided application when installed on user's computing device enables the head-mounted device to use the user's device as its computing unit performing all the logical operations on the digital sensor data acquired by head-mounted device and sent to computing device.

In an embodiment of the present invention, a secure transmission of data may embody sending signals directly through the body electro-quasistatic human-body communication.

In an embodiment of the present invention, the head-mounted device may be connected to computing device by wired mode or wireless mode including but not limited to Bluetooth, near field communication and Wi-Fi.

In an embodiment of the present invention, the head-mounted device may be provided with a microcontroller or microprocessor to perform basic operations while the computing device is not available.

In an embodiment of the present invention, the head-mounted device and the application installed on user's device may be configured to shift computing load from head-mounted device to user's device.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

However, for a more complete understanding of the above listed features and advantages of the system, methods and computer program products, reference should be made to the detailed description and the drawings. Further, additional features and advantages of the invention are described in, and will be apparent from, the detailed description of the preferred embodiments.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an exemplary embodiment of head-mounted device according to various embodiments of the present invention;

FIG. 2 illustrates an exemplary embodiment of head-mounted device electronically coupled to user's computing device;

FIG. 3 illustrates an exemplary system implementing various embodiments of the present invention.

FIG. 4 illustrates an exemplary system comprising a plurality of sensors coupled to a computing device of higher processing power, comprising a body area network.

### DETAILED DESCRIPTION OF THE PREFERRED EMBODIMENTS

Hereinafter, some embodiments considered most apparent in the understanding of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

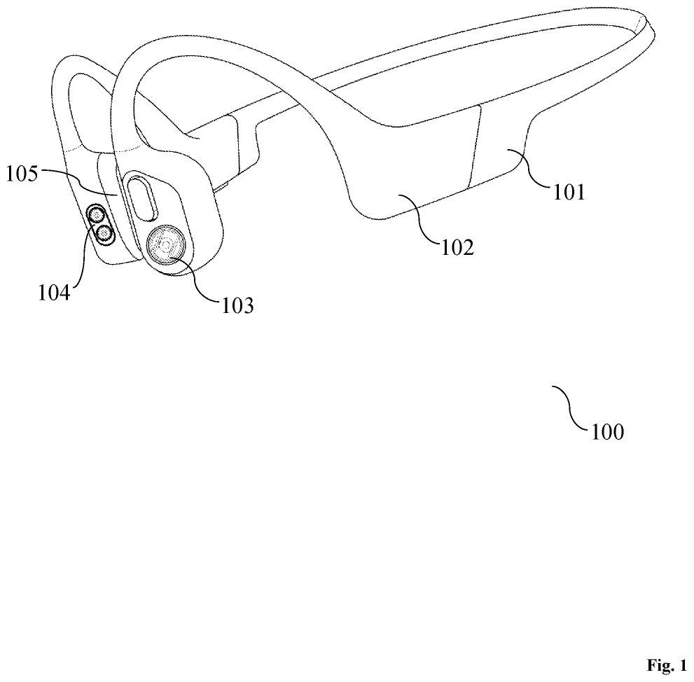

With reference now to the drawings, and in particular to FIG. 1 to FIG. 3 hereof, a system, method and computer program products for distributed computing enabled head-mounted devices embodying at least in part the principles and concepts of the present invention is described.

Reference is now made to FIG. 1, illustrating an exemplary non-limiting embodiment 100 of the present invention wherein the head-mounted device comprises of plurality of sensors including but not limited to: front camera 104, side camera 103, microphone 102, speaker 105, and battery 101. The front camera 104 and side camera 103 with 270-degree view are configured to capture the surroundings in video format along with the audio data received captured from the microphone 102.

The front camera 104 and side camera 103 may be that one or more cameras captures the view, one is a depth camera, and either is a neuromorphic event-driven camera, or even LiDAR. Further anticipated in the device shown in FIG. 1 may be biopotential sensors like electrocardiogram (ECG) and electromyography (EMG) sensors. In this embodiment, the electrocardiogram (ECG) is a sensor and capable of simple test that can be used to check your heart's rhythm and electrical activity, while EMG sensor is capable of a diagnostic procedure to assess the health of muscles and the nerve cells that control them (motor neurons). EMG results can reveal nerve dysfunction, muscle dysfunction or problems with nerve-to-muscle signal transmission, among others.

However, other types of sensors are also anticipated, such as those capable of sending signals directly through the body electro-quasistatic human-body communication. It is known that water filled with conductive particles like electrolytes and salts conducts electricity better.

The human body is filled with a watery solution called the interstitial fluid that sits underneath the skin and around the cells of the body. The interstitial fluid is responsible for carrying nutrients from the bloodstream to the body's cells, and is filled with proteins, salts, sugars, hormones, neurotransmitters, and all sorts of other molecules that help keep the body going. Because interstitial fluid is everywhere in the body, it allows the establishment of a circuit between two or more communicating devices sitting pretty much anywhere on the body.

In an embodiment of the present invention, the head-mounted device may comprise a Bluetooth card, a network interface card or near field communication card to wirelessly connect with the user's device in order to send data collected by sensors to a computing device provided for further processing of collected data.

As an example using an insulin pump, the pump, the monitor, and the head-mounted device would each be outfitted with an electrode on its back (e.g. copper), in direct contact with the skin. Each device may also have a second electrode not in contact with the skin that functions as a sort of floating ground, which is a local electrical ground that is not directly connected with Earth's ground. When the monitor takes a blood glucose measurement, it will need to send that data to both the pump, in case the insulin level needs to be adjusted, and to the head-mounted device, so that the individual can see the level. The head-mounted device may also be adapted to store data for long-term monitoring, or encrypt it and send it to a computer, for remote storage and analysis.

The monitor communicates its glucose measurements by encoding the data into a series of voltage values. Then, it transmits these values by applying a voltage between its two copper electrodes—the one touching the human body, and the one acting as a floating ground. This applied voltage very slightly changes the potential of the entire body with respect to Earth's ground. Because both the pump on the waist as well as the head-mounted device on the head are on the body, they can detect this change in potential across their own two electrodes—both on-body and floating. The pump and the head-mounted device then convert these potential measurements back into data. All without the actual signal ever traveling beyond the skin.

In an embodiment of the present invention, the head-mounted device has a compact and lightweight design allowing users to wear it as over the ear headset.

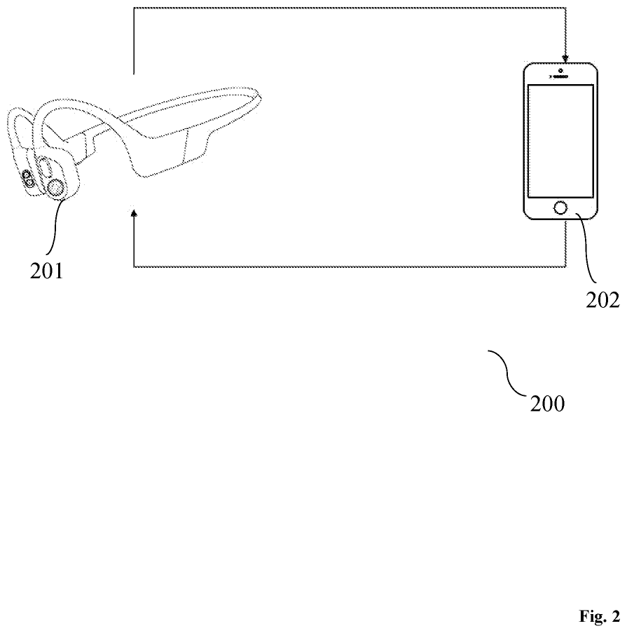

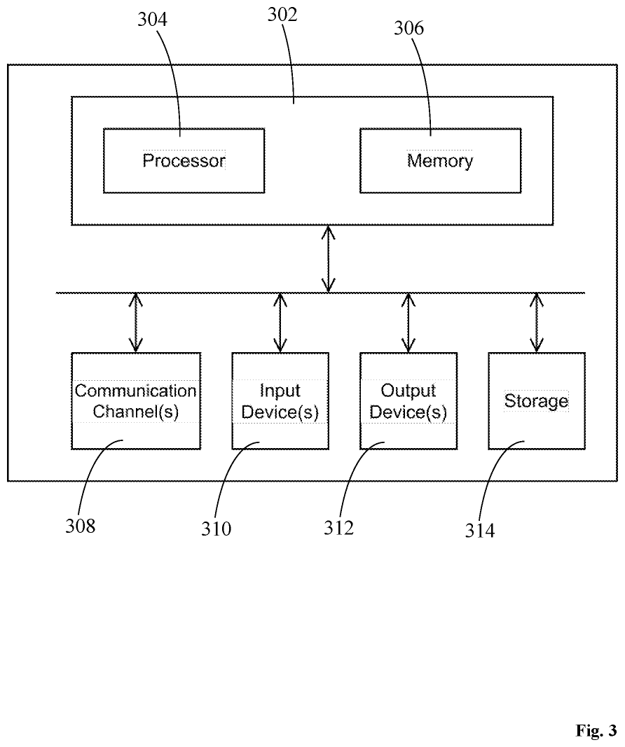

Reference is now made to FIG. 2, illustrating an embodiment 200 of the present invention wherein the head-mounted device 201 is communicably coupled to user's computing device 202 including but not limited to: phone, phablet, tablet, laptop, computer, etc. to send streams of data collected from various sensors present in the head-mounted device to wired or wirelessly coupled electronic computing device (as illustrated in FIG. 3) equipped with processor, memory and storage to acquire and process the received data and send required feedback to the head-mounted device to carry out the operations.

In an embodiment of the present invention, the user may be provided with a computer program application along with the head-mounted device which when installed in electronically coupled user device enables full control of user over the operations and features of head-mounted device. For example, the data streamed form the head-mounted device may be received in either raw, semi-processed or processed format at the coupled electronic computing device. The device 202 is capable of at least in part of receiving the data and storing it, generating a model of a human view with a corresponding sensor data, and transmitting the processed model for rendering by the head-mounted device 201.

In various embodiments, the invention additionally comprises a computer program product comprising a non-transitory computer readable medium having a computer readable program code embodiment therein—said computer readable program code comprising instructions for implementation of any of the method embodiments described above.

It is anticipated that the device 202 is capable of processing received data using at least one processor and a computer program product comprising a sequence of instructions configured on its memory that is adapted to generate a model of a human view with a corresponding sensor data and transmit the processed model for rendering by the head-mounted device 201.

It is further anticipated that the device 202 may further be coupled to one or more computing devices, a cloud-based processing tier, a peer-to-peer computer network or any such, and they may be involved in batch or parallel processing of data received from the head-mounted device. The computers may be adapted to produce large-scale compute power or a distribution of concerns between multiple computers.

In an embodiment of the present invention, head-mounted device may be connected to computing device by wired mode or wireless mode including but not limited to Bluetooth, near field communication, and Wi-Fi.

In an embodiment of the present invention, head-mounted device may be adapted to receive data from its various sensors and receivers. The data may subsequently be transmitted in raw, semi-processed or processed format to a processor, which may be internal to the device, or an external computer 202. The head-mounted device may then receive a generated model of a human comprising the transmitted data, for example showing the heart rate, insulin level, or any other measurement. Thereafter, the head-mounted device may render the model on the display apparatus provided and activate any number signals in response to at least in part the processed data and rendered model. For example, a visual display on the display apparatus, an audio signal may be transmitted to the speaker, a vibration may be triggered, or a signal to activate a sensor or monitor or actuator may be activated e.g. activating an insulin correction, readjusting a pacemaker, among others.

In alternative embodiments of the present invention, the head-mounted device may be provided with a microcontroller or microprocessor to perform basic operations while the computing device is not available.

In an embodiment of the present invention, the head-mounted device and the application installed on user's device may be configured to shift computing load from head-mounted device to user's device.

FIG. 3 illustrates an exemplary system 300 for implementing the present invention. The computer system 302 comprises one or more processors 304 and at least one memory 306. Processor 304 is configured to execute program instructions - and may be a real processor or a virtual processor. It will be understood that computer system 302 does not suggest any limitation as to scope of use or functionality of described embodiments. The computer system 302 may include, but is not be limited to, one or more of a general-purpose computer, a programmed microprocessor, a micro-controller, an integrated circuit, and other devices or arrangements of devices that are capable of implementing the steps that constitute the methods of the present invention. Exemplary embodiments of a computer system 302 in accordance with the present invention may include one or more servers, desktops, laptops, tablets, smart phones, mobile phones, mobile communication devices, tablets, phablets and personal digital assistants. In an embodiment of the present invention, the memory 306 may store software for implementing various embodiments of the present invention. The computer system 302 may have additional components. For example, the computer system 302 may include one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various software(s) executing in the computer system 302 using a processor 304, and manages different function and features of the components of the computer system 302.

The communication channel(s) 308 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth, IEEE 802.15.6, IEEE 802.15.4, IEEE 802.15.3 compliant networking protocols or other transmission media.

The input device(s) 310 may include, but is not limited to, a touch screen, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 302.

The storage 314 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 302. In various embodiments of the present invention, the storage 314 may contain program instructions for implementing any of the described embodiments.

In an embodiment of the present invention, the computer system 302 is part of a distributed network or a part of a set of available cloud resources.

In an embodiment, the present invention may be applicable to any such wearable compute apparatus, comprising a plurality of sensors, but whose processing power is in a separate computing device near the device in a boy area network. To further illustrate, the utility advantage of this implementation is that the wearable device becomes lightweight as it does

The present invention may be implemented in numerous ways including as a system, a method, or a computer program product such as a computer readable storage medium or a computer network wherein programming instructions are communicated from a remote location.

In some aspects, the present invention may suitably be embodied as a computer program product for use with the computer system 302. The method described herein is typically implemented as a computer program product, comprising a set of program instructions that is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

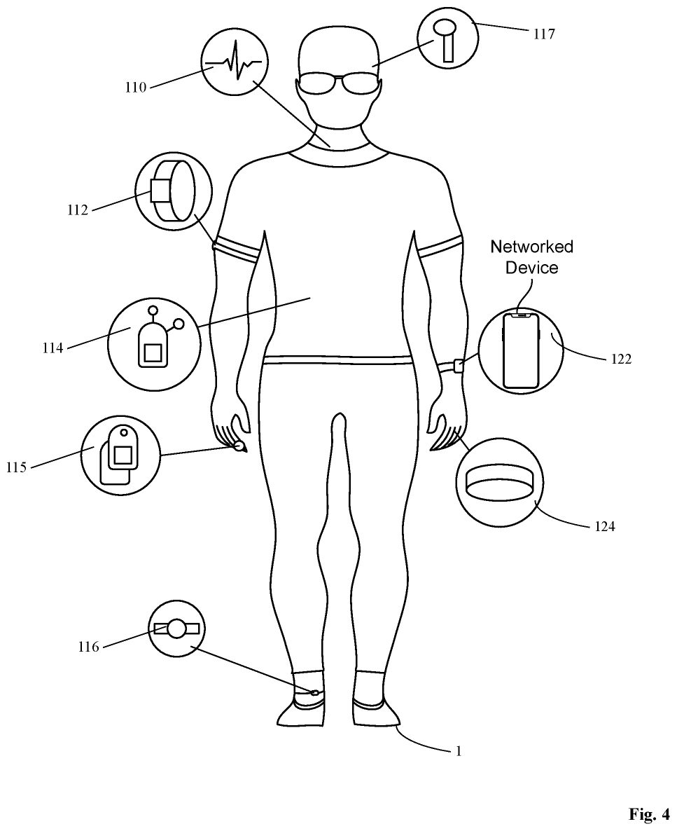

Further, and referring to FIG. 4, it is illustrated an exemplary system comprising a plurality of sensors coupled to a computing device of higher processing power, comprising a body area network. In the figure, it is illustrated a person 1, on whose body is a plurality of sensors 110, 112, 114, 115, 116, 117 and 124. The sensors are operably coupled to a networked device 122 of higher processing power, the device being located on or in close proximity to the body. For the avoidance of doubt, the sensors may include any such measuring devices worn on the body or placed inside the body such as but not limited to smart-watches, heart monitors, insulin sensors, glucose sensors, woven activity sensors, hydration sensors, non-woven activity sensors, or any such. The sensors may be adapted to share data with a coupled computing device via using wireless techniques, including but not limited to microwave, infrared, Bluetooth or other transmission techniques.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The invention is applicable in the computing industry, specifically in the construction and operation of distributed computing systems for wearable devices.

What is claimed is:

1. A distributed body area network (BAN) [1,2] computing system, comprising at least two computing devices such that one may be a “head mountable” device and the other is a networked device of higher computing power and larger battery, said networked device being placed elsewhere but in the vicinity of the first member and the body, wherein:
the “head-mountable” device embodies a lightweight apparatus, and comprises a plurality of sensors including at least in part of: one or more cameras capturing the field of view, a depth camera, a neuromorphic event-driven camera, LiDAR, microphone, speaker, biopotential sensors such as electrocardiogram(ECG), electromyography(EMG) sensor, and a battery; and
the networked device comprises at least a processor for data processing, wherein said device may be directly, or through another device, operably coupled to a computer or computer network via a network such as Wi-Fi, cellular network or any such. The method of claim 1, further comprising the transmission of a signal based at least in part on received generated model and processed received data to an actuation mechanism coupled to the augmented reality headset.

2. The distributed BAN computing system according to claim 1, wherein said networked device comprises a wearable cloud connected computing device such as smartphone, smart-watch or any such.

3. The distributed BAN computing system according to claim 1, wherein said “head mountable” device and networked device are linked by means of Wi-Fi or any personal area network communication technologies such as IEEE 802.15.6[3], IEEE 802.15.4 [4], IEEE 802.15.3 [5] compliant networking protocols.

4. The distributed BAN computing system according to claim 1, wherein said “head-mountable” device comprises a means for performing functions of sensing, in-sensor processing including but not limited to feature extraction, compression, and transmits raw or processed data using ultra-low-power communication to the networked device, wherein said network device processes received data and transmits a response to the “head-mountable” device.

5. The distributed BAN computing system according to claim 4, wherein the “head-mountable” device performs an actuation or feedback, which may include at least in part of a speaker activation, bone conduction, or vibration.

6. The distributed computing system according to claim 4, wherein the networked device processes received data either locally or by transmitting the data to an external computing resource and provides the processed response back to the transmitting “head-mountable” device.

7. The distributed computing system according to claim 1, wherein transmission of data between the “head-mountable” device and the networked device is performed by means of one or more of a radio frequency, Bluetooth, Wi-Fi, near-field communication or any other personal area network communication technology e.g. IEEE 802.15.6, IEEE 802.15.4, IEEE 802.15.3 compliant networking protocols.

8. The distributed computing system according to claim 1, wherein the “head-mountable” device may be configured to display a first person view to the wearer, the view indicating senses including but not limited to audio visual experience.

9. The distributed computing system according to claim 1, wherein the “head-mountable” device may be further configured to view the wearer's face by use of a protrusion, which could be a removable attachment or a fixed part.

10. The distributed computing system according to claim 1, wherein the “head-mountable” device may be configured to measure body parameters including at least in part of physiological signals, heart rate, temperature.

11. The distributed computing system according to claim 1, wherein the “head-mountable” device may be configured to measure ambient parameters including at least in part of temperature, surrounding vision, humidity.

12. The distributed computing system according to claim 1, wherein the networked device may be configured to measure body parameters including at least in part of physiological signals, heart rate, temperature.

13. The distributed computing system according to claim 1, wherein the networked device is further configured to actuate alerts and/or signals to a wearer, said alerts and/or signals including at least in part of speaker actuation, vibrational feedback, neurostimulation.

14. A computer program product comprising a sequence of instructions stored in a non-transitory computer-readable medium, executable by at least a processor, the execution of which cases the implementation of a method comprising:
receiving data from a plurality of sensors operably coupled to an “head-mountable” device;
transmitting received data to a processing means in raw, semi-processed and/or processed format;
receiving a feedback or actuation at the “head-mountable” device a signal comprising processed received data; and
actuating a feedback by the “head-mountable” device.

15. The computer program product of claim 14, wherein actuating the feedback further causes the transmission of a signal based at least in part on received feedback or actuation and processed received data to an actuation mechanism coupled to the “head-mountable” device.

16. A method performed by distributed body area network (BAN) computing system, the method comprising of:
receiving data from a plurality of sensors operably coupled to the networked device;
processing received data to understand the environment of the wearer, physiological condition of the body by the networked device; and
rendering the generated model of the human, the environment as well as feedback based on the received data.

17. The method of claim 16, further comprising the transmitting a signal based at least in part on generated model and processed received data to an actuation mechanism coupled to the “head-mountable” device.

18. The method of claim 16, wherein the rendering of generated model and the feedback comprises at least one or more of:
an audio output from a speaker;
a video on a display apparatus; and/or
a vibration.
